(19) United States
(12) Patent Application Publication
(10) Pub. No.: US 2009/0099304 A1
(43) Pub. Date: Apr. 16, 2009

(54) Method For Increasing The Efficiency of Surfactants and Emulsifiers By Means of Additives

(76) Inventors: Jurgen Allgaier, Aachen (DE); Henrich Frielinghaus, Koln (DE); Christian Frank, Kerpen/Horrem (DE)

Correspondence Address: K.F. ROSS P.C., 5683 RIVERDALE AVENUE, SUITE 203 BOX 900, BRONX, NY, 10471-0900, US

(21) Appl. No.: 11/792,387

(22) PCT Filed: Dec. 1, 2005
(86) PCT No.: PCT/DE05/02165

§ 371 Date: Jun. 5, 2007

(30) Foreign Application Priority Data
Dec. 8, 2004 (DE) 10 2004 058 956.9

(51) Int. Cl. C08G 81/00

(52) U.S. Cl. 524/612

(57) ABSTRACT

The invention relates to a method for improving the efficiency of surfactants with the simultaneous suppression of lamellar mesophases, in particular in micro-emulsions and emulsions and to surfactants, which are mixed with an additive. According to the invention, to improve the efficiency of the surfactants, a block copolymer of type AB, ABA or BAB is added to latter, said polymer comprising a water-soluble block A and an oil-soluble block B, which is a polyalkylene oxide, whose monomer units contain at least 4 carbon atoms. Said block copolymers also prevent lamellar mesophases, stabilise the temperature of the one-phase ranges for oil, water or surfactant mixtures, enlarge the structural quantity and reduce the interfacial tension of said mixtures.

The invention relates to a method for increasing the efficiency of surfactants and emulsifiers by means of additives, in particular in microemulsions and emulsions.

According to the prior art, emulsions and microemulsions are stabilized by nonionic, anionic, or cationic surfactants or emulsifiers, for example. Use of the term “surfactant” below expressly includes emulsifiers.

Surfactants are able to solubilize liquids that are immiscible with water (oils), or to solubilize water in oil. The efficiency of surfactants is expressed as the quantity of surfactant that is necessary to solubilize a given quantity of oil in water, or vice versa. For water-oil-surfactant mixtures, a basic distinction is made between emulsions and microemulsions. Microemulsions are thermodynamically stable, whereas emulsions are thermodynamically unstable and decompose.

Emulsions and microemulsions find commercial application, for example, in cleansing and personal care products, hair and body care products, in plant protection for stabilization of microbiocidal active substances, in the production of paint and varnish systems, and in the pharmaceutical sector.

In the commercial formulation of emulsions and microemulsions, however, undesirable lamellar mesophases often occur. Lamellar mesophases result in optical anisotropy and increased viscosity. These characteristics are unfavorable for detergents, for example, since the lamellar mesophases cannot be washed out. Lamellar mesophases are also undesirable for plant protection because they result in plugging of the spray nozzles.

A further problem in the commercial formulation of emulsions and microemulsions is temperature behavior. In general, particularly as the result of addition of an additive, single-phase regions that are important for the commercial application are shifted into other temperature regions. The shifts may be in the range of 10° C. and higher. However, this requires that formulations be changed in order to adapt them to the newly established temperature behavior in the single-phase region.

There is also the need to obtain consistent quality in formulations while economizing on surfactants. In addition to cost reasons, economizing on surfactants may also be advantageous for environmental reasons. Furthermore, surfactants that are used for product stabilization are often undesired in actual use.

German Patent Application 198 39 054.8-41 [U.S. Pat. No. 6,677,293] discloses a method for increasing the efficiency of surfactants while simultaneously suppressing lamellar mesophases, a method for stabilizing the temperature level of the single-phase region for oil, water, and surfactant mixtures, a method for increasing the structural size of emulsified liquid particles in microemulsions, and a method for reducing the interfacial tension of oil-water mixtures in which AB block copolymers comprising a water-soluble block A and a water-insoluble block B are added.

It has been shown that AB block copolymers containing PEO as the water-soluble block (polyethylene oxide) and a polyalkane as the water-insoluble block are particularly suited as additives. However, preparation is possible only in a multistage process under various reaction conditions. In the first step a diene (butadiene or isoprene) is polymerized by use of an organolithium initiator. This is followed by OH functionalization of the polymer chains with ethylene oxide. The remaining carbon double bonds in the polymer are then hydrogenated. A polyalkane is obtained as an intermediate product in which each polymer chain is functionalized by an alcoholic OH group. In an analogy to ethoxylation of fatty alcohols, ethylene oxide is then graft polymerized onto the polyalkane alcohol by first converting the polyalkane alcohol to the corresponding sodium or potassium alcoholate.

This method requires the use of expensive organolithium compounds, extremely high-purity conditions for the anionic diene polymerization, and isolation and purification of the polyalkane alcohol obtained as intermediate product. The preparation of polyalkane-PEO block copolymers is therefore costly. In addition, high viscosities appear during ethoxylation of the polyalkane, in particular when no solvent is added. The increase in viscosity is most pronounced when a state is reached during the block copolymer formation in which the two polymer blocks are present in approximately the same volume proportions. The high viscosity then results from microphase separation of the two polymer blocks and formation of lamellar superstructures. The high viscosity of the polymer impedes or prevents the stirring process in the reactor, with adverse effects for the course of the reaction. To reduce the viscosity, solvents must be used or the reaction temperature must be greatly increased. Aside from the preparation process, high viscosities are also problematic in the formulation of polyalkane-polyethylene oxide block copolymers in products.

The object of the invention, therefore, is to increase the efficiency of surfactants and emulsifiers in emulsions or microemulsions, and to reduce the interfacial tension by use of polymers which may be easily prepared and simply formulated. The aim is to stabilize emulsions and microemulsions using less surfactant, i.e. to economize on surfactant in formulations. A further aim is to suppress the occurrence of lamellar phases in microemulsions. The temperature behavior of the emulsions and microemulsions should remain unaffected by additives; i.e. the location of the single-phase region in the phase diagram should not be significantly influenced with regard to temperature by adding the additives. A further aim is to provide an additive which achieves the above-referenced advantages and which allows admixture of a cleaning agent, for example, without having to change the composition of the remaining formulation. A further aim is to provide an additive which can be used in cleaners and/or emulsions and/or microemulsions, resulting in a reduction of the quantity of surfactant necessary for effectiveness. Included are household cleansers, cleaners for the commercial sector and for industrial processes, hair and body care products, foods, plant pest control products, paints and varnishes, pharmaceuticals, and conditioners and ingredients for household, commercial, and industrial applications. This additive should be particularly easy to prepare, and be capable of emulsifying oils in water or water in oils. It is thus possible to prepare microemulsions having emulsified liquid particle sizes that correspond to those of emulsions.

Surprisingly, proceeding from the preamble of claim 1 all objects of the invention have been achieved by using as additive a polyalkylene oxide block copolymer comprising a water-soluble block A and an oil-soluble block B.

Block A is preferably insoluble in oil, and

Block B is preferably insoluble in water.

Block A is preferably composed of PEO, although copolymers of ethylene oxide with higher alkylene oxides such as propylene oxide and/or butylene oxide are also possible while still maintaining the water solubility of block A.

The monomer components may be present in block A in any given sequence. It is preferable for the individual components to be at least partially alternating.

In one further preferred embodiment, the monomer units of block A have a stochastic sequence.

It is also preferable for block A to be insoluble in oil.

In contrast, block B is preferably an oil-soluble polyalkylene oxide containing at least four carbon atoms in the monomer unit, preferably polybutylene oxide, polypentylene oxide, and polyhexylene oxide, as well as other polyalkylene oxides containing at least four carbon atoms in the monomer unit.

A block B may be composed of at least two components from the group comprising polybutylene oxide, polypentylene oxide, and polyhexylene oxide, as well as other polyalkylene oxides containing at least four carbon atoms in the monomer unit.

Block B may also be composed of ethylene oxide, as long as solubility in oil is provided.

Block B should also preferably be insoluble in water.

Furthermore, triblocks having the ABA or BAB structure as well as star polymers having the (AB)ₙ or (BA)ₙ structure may be used, where n stands for the number of arms in the star polymer, and the center of the star structure is, for example, an n-hydric alcohol where n=the number of OH groups, or an m-valent amine where m=the number of amino groups and n=the number of H atoms bound to nitrogen. For (AB)ₙ, component A is bound to the center of the star, and for (BA)ₙ, component B is bound to the center of the star.

The efficiency of the surfactants is expressed as the quantity of surfactant that is necessary to solubilize a given quantity of oil in water, or vice versa. The smaller the quantity of surfactant that is necessary for the same level of activity, the higher the efficiency. An increase in efficiency is also obtained when, for the same surfactant concentration, an emulsion is stable for a longer period of time when an efficiency-increasing additive is added. An increase in efficiency in the sense of the invention is obtained when at least one of the two possibilities is satisfied.

Advantageous refinements of the invention are stated in the subclaims.

Blocks A and B may preferably have molecular weights between 1000 g/mol and 50,000 g/mol, particularly preferably between 3000 g/mol and 20,000 g/mol.

A polyethylene oxide block is preferably used as block A. A copolymer of ethylene oxide and propylene oxide that is soluble in water is also used as block A.

A polyalkylene oxide block containing at least four C atoms in the monomer unit is used according to the invention as block B.

The AB block copolymers used according to the invention may preferably be obtained from alkoxylation by sequential polymerization of the blocks.

Block B is advantageously soluble in mineral oils or aliphatic hydrocarbons such as ester oils.

Particularly advantageous properties of the AB block copolymers used according to the invention are observed in application products when the molecular weights of Blocks A and B are in the range of 3000-20,000 g/mol. Polymers having these comparatively low molecular weights are readily and quickly soluble; i.e. the polymers may be easily incorporated into the surfactant.

In the AB block copolymers used according to the invention, the two blocks A and B should have the greatest possible difference in polarity, Block A being as polar as possible and Block B being as nonpolar as possible, thereby increasing the amphiphilic behavior.

Block A is water-soluble, and Block B is soluble in nonpolar media.

Block B is advantageously soluble in mineral oils, high-boiling esters, or aliphatic hydrocarbons or in mineral oils. This is preferably also the case at room temperature.

Furthermore, the AB triblock copolymers having the ABA and BAB pattern as well as star polymers having this monomer sequence have the same activity according to the invention, and are therefore encompassed by the invention.

Star polymers having the (AB)ₙ or (BA)ₙ structure are also encompassed by the invention, where n stands for the number of atoms in the star polymer, and the center of the star structure is, for example, an n-hydric alcohol where n=the number of OH groups, or an n-valent amine where n=the number of amino groups. These star polymers likewise have the activity according to the invention.

By way of example, but not in a limiting manner, the following surfactants/emulsifiers (C) and mixtures thereof with the additives according to the invention may be used:

Nonionic surfactants of the alkyl polyglycol ether class (CᵢEⱼ) where i≧8 (C═C atoms in the alkyl chain, E=ethylene oxide unit),

Nonionic surfactants of the alkyl polyglucoside class (APG, “sugar surfactants,” CᵢGⱼ where i≧0.8) with cosurfactant alcohol (Cₓ—OH, x≧6),

Anionic surfactants, for example AOT (sodium bis(2-ethylhexyl)sulfosuccinate), alkyl sulfate, alkyl sulfonate,

Cationic surfactants,

Mixtures of surfactants, in particular nonionic/anionic.

According to the invention, when the polyalkylene oxide block copolymers are added to the water-oil-surfactant mixture the location of the single-phase region in the phase diagram remains in the same temperature range, the efficiency of the surfactant mixture is significantly increased, lamellar mesophases are controlled in microemulsions, and the interfacial tension is reduced. In addition, microemulsions maintain their characteristic properties when their structural size is increased; emulsified structural sizes of up to approximately 2000 angstrom are obtained. The size of the emulsified liquid particles depends on the temperature and the quantity of block copolymer added, and therefore on the composition of the surfactant mixture. The additives according to the invention are suitable for industrial cleaning processes and emulsification processes. The additives emulsify organic, water-insoluble substances present in liquid form in the emulsification process, and vice versa (w/o and o/w), and are particularly easy to prepare.

Preparation of polyalkylene oxide block copolymers is much easier than preparation of polyalkane-PEO block copolymers. The synthesis may be carried out in a one-vessel process, using low-molecular sodium or potassium alcoholates, for example sodium methanolate, sodium ethanolate, sodium tert-butanolate, potassium methanolate, potassium ethanolate, or potassium tert-butanolate.

Alcoholate/alcohol mixtures may also be used.

The polymerization is carried out by first polymerizing an alkylene oxide (optionally ethylene oxide or the higher alkylene oxide), and after polymerization is complete the other alkylene oxide is graft polymerized. Isolation and purification of an intermediate product is omitted. The preparation method is particularly simple, since the product may be obtained in a one-vessel reaction without intermediate work-up. In addition, during the polymerization of the second monomer much lower viscosities occur than for polyalkane-PEO-block copolymers. In the block copolymer preparation it is therefore possible to use less solvent or to omit same, or less heat is required for the reaction temperature than for polyalkane-PEO [block] copolymers.

Polyalkylene oxide block copolymers are more easily prepared than polyalkane-PEO block copolymers on account of the lower viscosity. Polyalkylene oxide block copolymers are also easier to formulate, since the dissolving and mixing procedures proceed more quickly.

The different viscosity behavior is demonstrated by way of example for two diblock copolymers, each composed of approximately 50 vol-% PEO (Table 1). PEB5-PE05 is a polyalkane-PEO block copolymer containing poly(ethylene-co-butylene) as hydrophobic block, with an ethylene to 1-butylene monomer unit ratio of 2:1. Table 1 shows the molecular weight characterization of the two diblock copolymers.

The viscosities of the two block copolymers were measured at various temperatures using an ARES rheometer from Rheometric Science. To this end, approximately 0.5 g block copolymer at 70° C. was processed into a homogeneous blank 25 mm in diameter and 1 mm thick.

The viscosities for the frequencies ω=1/sec and ω=10/sec for various temperatures are listed in Table 2. The measured viscosity values for the two block copolymers are high compared to homopolymers of the same molecular weights, since in each case two blocks are present in approximately the same volume proportions, and lamellar microphase separation therefore occurs. However, the viscosity of the polyalkylene oxide block copolymer is approximately 3 times lower than that of the polyalkane-PEO block copolymer, although the molecular weight of the former is 1.6 times higher.

In addition to the viscosity behavior, the miscibility of the components is of key importance for ease of formulation. Polyalkane-PEO block copolymers are generally immiscible with surfactants or emulsifiers, resulting in stability problems during storage. The mixtures may also solidify, which causes difficulties in handling. Alternatively, the components must be separately metered in use, or heated, or large quantities of water must be added to homogeneously mix the polymer and surfactant.

On the other hand, polyalkylene oxide block copolymers are generally miscible with surfactants, or small quantities of water are sufficient to produce homogeneous block copolymer/surfactant mixtures.

For the surfactants and emulsifiers listed in Table 3, mixtures with the polymers listed in Table 1 were prepared to test the miscibility. Both polymers are wax-like solids at room temperature, and the surfactants and emulsifiers are liquid. Table 3 shows surfactants and emulsifiers for mixed tests with polymers.

The trade names stated in the examples refer to surfactants or emulsifiers which are examples of the substance classes given below:

Tergitol® 15-S-5: PEG ether of a mixture of synthetic C11-15 fatty alcohols with approximately 5 mol EO

Tergitol® 15-S-12: PEG ether of a mixture of synthetic C11-15 fatty alcohols with approximately 12 mol EO

Tween® 80: Mixture of oleate esters of sorbitol and sorbitol anhydrides with approximately 20 mol EO

Tween® 81: Mixture of oleate esters of sorbitol and sorbitol anhydrides with approximately 5 mol EO

Span® 20: Monoesters of lauryl acid and hexitol anhydride derivatives of sorbitol.

Mixtures of 90 wt-% surfactant and 10 wt-% polymer were stirred for 1.5 hours at room temperature and for 1.5 hours at 50° C. All mixtures were clear and liquid after stirring at 50° C. The appearance after cooling to room temperature is summarized in Table 4.

The mixtures were then combined with deionized water such that the water proportion was 10 wt-%. Stirring was performed once again for 1.5 hours at 50° C. At this temperature all mixtures were again clear and liquid, and only the mixtures of PEBt-PEO5 with Tween® 80, Tween® 81, and Span® 20 showed slight cloudiness. The appearance after recooling to room temperature is also summarized in Table 4.

Of the surfactant mixtures with PBO5-PE05, three were liquid and three were solid, whereas of the surfactant mixtures with PEB5-PEO5 only one was liquid and five were solid. After addition of 10% water to the surfactant-polymer mixture, all of the PBO5-PE05-containing mixtures were liquid and homogeneous, whereas the polymer precipitated for all mixtures containing PEB5-PEO5.

The appearance of the mixtures did not change after five days' storage at room temperature.

The invention is described below by way of example.

The AB block copolymers according to the invention may be prepared in the manner stated below by way of example.

Preparation methods for polyalkylene oxide block copolymers, using poly(1,2-butylene oxide)-polyethylene oxide block copolymer as an example:

2.8 mL of a 0.90 molar potassium tert-butanolate solution in THF was added to a 0.5-L steel reactor swept with argon shield gas. The solvent was distilled off under vacuum. 0.22 g tert-butanol and 27.7 g 1,2-butylene oxide were then condensed in the cooled reactor. The mixture was heated for 17 hours at 80° C. under argon positive pressure, with stirring. Unpolymerized butylene oxide was then distilled off under vacuum (1.3 g), and 29 g anhydrous toluene was condensed in the cooled reactor. 13.5 g of the polymer-toluene mixture was withdrawn from the reactor for separate analysis of the PBO block. 20.8 g ethylene oxide was then condensed in the cooled reactor. The mixture was heated for 15 hours at 60° C. under argon positive pressure, with stirring. 1 mL acetic acid was added, and the product mixture was discharged through a bottom valve. After distillation of the solvent a wax-like mass was obtained, which was dried overnight under vacuum to remove residual solvent and acetic acid. 40.6 g block copolymer was obtained. Instead of acetic acid an alkylation agent such as methyl or ethyl chloride may be added.

The molecular weight of the PBO block was determined using ¹H-NMR by comparing the signal intensity of the tert-butyl initiator unit with the intensities of the polymer signals. The composition of the polymer, and thus the molecular weight of the PEO block, was obtained using ¹H-NMR by comparing the intensities of the PBO signals with those of the PEO signals. Molecular weight distributions were determined by GPC, resulting in the values listed in Table 5.

The polymers listed in Table 6 were used for the analysis of the microemulsions and emulsions.

The polymers were characterized in the same manner as described in the preceding section. Only the PBO molecular weight of PEO2-PBO2-PEO2 was determined by GPC, using coupled online light scattering detection.

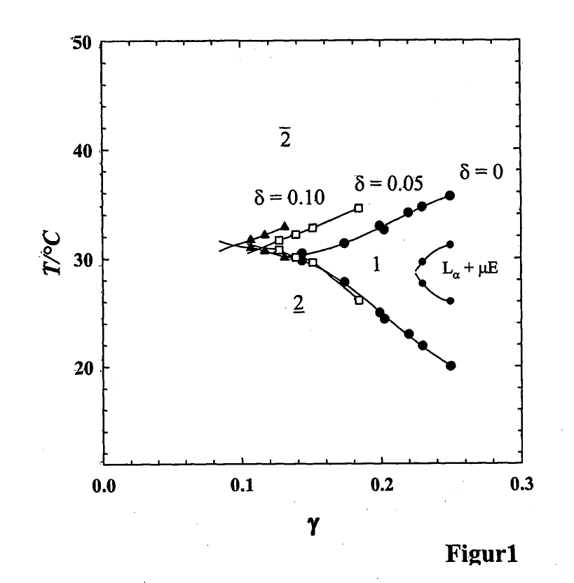

The characteristics of the microemulsions according to the invention are illustrated in FIGS. 1-4:

Several terms are defined below:

C=any given surfactant or emulsifier, such as an anionic, cationic, nonionic surfactant or sugar surfactant, and mixtures thereof containing at least two surfactants.

D=an additive which is added to the surfactant C according to the invention.

γ=total surfactant concentration (mass fraction) from C and D, for

$$γ = \frac{m ( C ) + m ( D )}{{m}_{gas}}$$

where

m=mass in g

γ=dimensionless mass fraction

m_{ges}=total mass of m_{water}+mₒᵢₗ+m(C)+m(D)

|\tilde{γ}=total surfactant concentration at the intersection point at which the single-phase region meets the three-phase region in the phase diagram. This corresponds to the minimum total surfactant concentration that is necessary for complete solubilization of water and oil at the stated water-oil ratio.

δ=mass fraction of additive D in the mixture of surfactant C+additive D, corresponding to

$$δ = \frac{m ( D )}{m ( C ) + m ( D )}$$

where

m=mass in g and

δ=mass fraction (dimensionless).

FIG. 1: Temperature/surfactant concentration diagram for the mixture of water-n-decane-C₁₀E₄- PBO5-PEO5 as a function of the addition of PBO5-PEO5 (δ) at a constant water-oil ratio of φ=0.5.

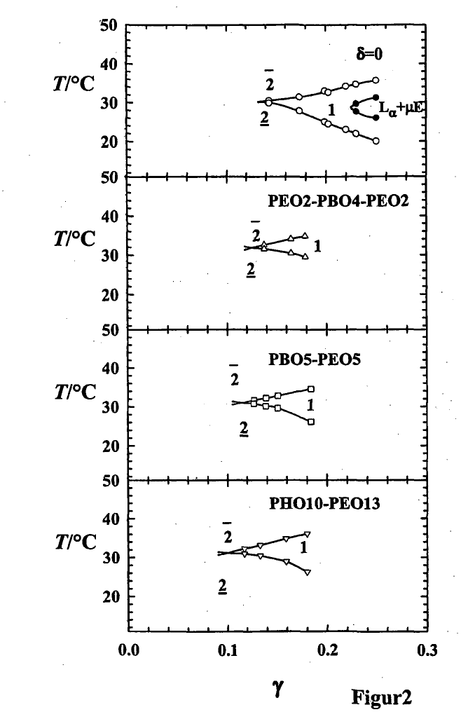

FIG. 2: Temperature/surfactant concentration diagram for the mixture of water-n-decane-C₁₀E₄-amphiphilic polymer for the polymers PEO2-PBO4-PEO2, PBO5-PEO5, PHO10-PEO13 for δ=0.05 and a constant water-oil ratio of φ=0.5. For comparison, the upper illustration shows the phase diagram of the system without additive (δ=0).

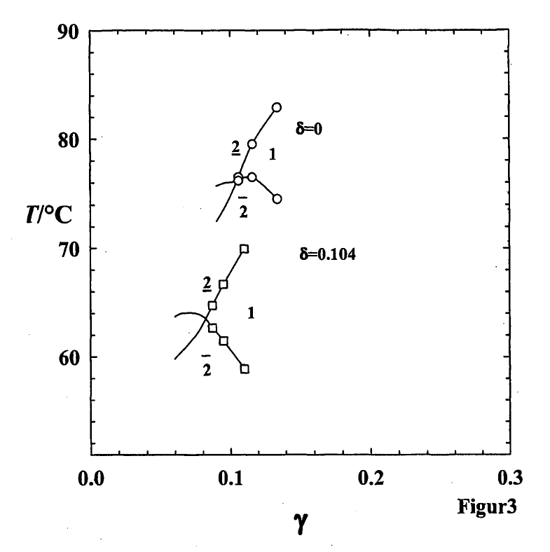

FIG. 3: Temperature/surfactant concentration diagram for the mixture of water/NaCl-n-decane-AOT, as an example of ionic surfactants, - PBO10-PEO13 as a function of the addition of PBO10-PEO13 (67) at a constant water-oil ratio of φ=0.5. The salt concentration in the water (ε) was 1%.

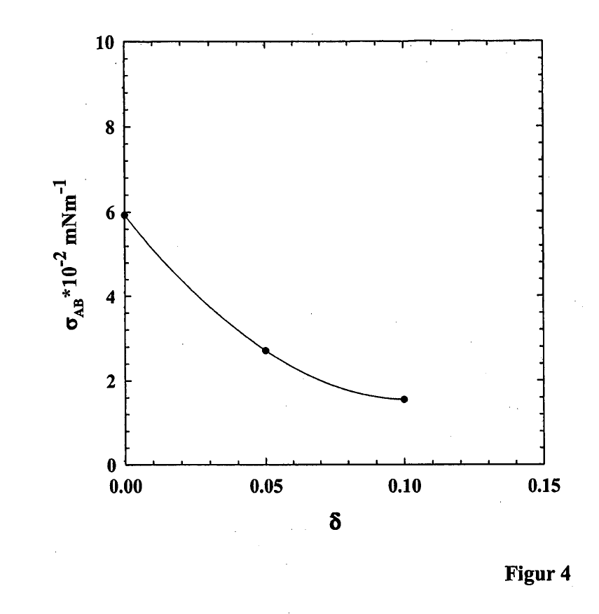

FIG. 4: Interfacial tension (σ_{ab}) between water and oil in the mixture of water-n-decane-C₈E₃- PBO5-PEO5 as a function of the addition of PBO5-PEO5 (67) at a constant temperature of T=22.4° C.

The T/γ diagrams illustrated in FIGS. 1-3 refer to systems having a constant water-oil volume ratio of 1:1, and are explained below.

When the temperature T is plotted against the total surfactant concentration γ, a single-phase region 1 is observed at higher surfactant concentrations. Adjoining this region in the direction of decreasing surfactant concentration is a closed three-phase region, which for the sake of clarity has been omitted in FIGS. 1-3. Two-phase regions 2 are present above and below the phase boundary lines.

These diagrams illustrate the curves for each δ value, which characterize the boundary of the particular single-phase region associated with a δ value. The peak of each respective curve is the point at which various multiphase regions meet. The further the peak of a curve is displaced at lower surfactant concentrations, i.e. γ values, the greater the efficiency of the surfactant C resulting from addition of the block copolymer D.

FIG. 1 shows the manner in which the efficiency of the total surfactant increases with the addition of the block copolymer. If a microemulsion is formulated from identical proportions of water or decane and C₁₀E₄, at a surfactant concentration of 12% (γ=0.12) only two- and three-phase regions are present between 0° C. and 100° C. If in the same mixture 10% of the surfactant C₁₀E₄ is replaced by the block copolymer PBO5-PEO5 (δ=0.10), a single-phase region is obtained between 30° C. and 32° C. In addition, only a very slight shift of the phase boundaries on the temperature axis is indicated. This is equivalent to stating that the location of the efficiency of the surfactant C with regard to its temperature of use remains essentially unchanged. In addition, no mesophases occurred in the test measurements, whereas in the system without additives a higher efficiency was equivalent to the appearance of lamellar mesophases in particular.

FIG. 2 shows an overview of the efficiency and the temperature level of various water-n-decane-C₁₀E₄-amphiphilic polymer systems for the polymers PEO2-PBO4-PEO2, PBO5-PEO5, PHO10-PE013 for δ=0.05 and a constant water-oil ratio of φ=0.5. For all the polymers used, an increase in efficiency and an essentially unchanged temperature level was observed in comparison to the starting system where δ=0. The increase in efficiency increases with increasing molecular weight of the triblock copolymer PEO2-PBO4-PEO2 with respect to the block copolymer PHO10- PEO13.

In FIG. 3 the same characteristics appear with regard to the temperature behavior. However, the increase in efficiency is more pronounced on account of the larger polymer PHO10-PEO13.

For a system containing block copolymers with increasing polymer content (δ), the values of the water-oil interfacial tension minimum in Table 7 and FIG. 4 sharply decrease. This characteristic is of critical importance for many washing and cleaning processes.

Example of increase in efficiency for emulsions:

Emulsions were prepared as emulsifiers composed of water, decane, and AOT. The water contained 0.30 wt-% NaCl. AOT was dissolved in the aqueous phase. The emulsions were prepared using an Ultra-Turrax® T 25 Basic (IKA-Werke) at a stirrer speed of 16,000 min⁻¹ over a period of 5 min. For a portion of the emulsions, in addition to AOT the nonionic surfactant Tergitol® 15-S-12 or the diblock copolymer PBO5-PEO5 was used. The compositions of the emulsions are listed in Table 8.

After the emulsification, the emulsions were filled into air-tight sealable test tubes and stored at room temperature. The stability of the emulsions was monitored over a period of 120 days. The quantity of precipitated oil was used as a measure of the stability.

The volume of precipitated oil relative to the total volume of the emulsions after various storage times is presented in Table 9. Whereas the emulsion 1 stabilized only with AOT was fairly unstable, emulsions 2 and 3 which additionally contained Tergitol® 15-S-12 had a much better stability, although they contained less surfactant overall. However, even these emulsions had largely decomposed after 120 days. The stability of emulsions 4 and 5 containing PBO5-PEO5 was greatest, although here as well larger quantities of AOT had been replaced by small quantities of polymer. The polymer-stabilized emulsions were stable even after 120 days. In other words, the polymer markedly improves the efficiency of the AOT emulsifier. The small amounts of oil precipitation for emulsions 2, 3, and 5 at the start of the storage tests were due to incomplete emulsification of the oil. The AB or ABA and BAB block copolymers may be prepared in a particularly simple manner in a one-vessel reaction.

By use of the AB block copolymers employed according to the invention, the interfacial tension of surfactants such as anionic, cationic, and nonionic surfactants, sugar surfactants, and in particular commercial surfactant mixtures, is reduced. The appearance of lamellar mesophases is suppressed. The temperature behavior of the emulsions and microemulsions remains unchanged; i.e. the location of the single-phase region with regard to the temperature in the phase diagram is not affected by the addition of the additives used according to the invention. Therefore, it is not necessary to change the formulation of a cleaner in order to provide a constant location of the single-phase region with regard to the temperature in the single-phase diagram.

The AB block copolymers as well as ABA and BAB triblock copolymers may preferably be used in commercial cleaners and for stabilizing emulsions and microemulsions, for example as additives in foods and cosmetics. Furthermore, they may preferably be used as lubricants in the metal and textile industries, or in paints and varnishes.

The microemulsions prepared by the addition of AB block copolymers according to the invention have emulsified liquid volumes corresponding to those of emulsions. The block copolymers according to the invention are particularly well suited for industrial cleaning processes.

The additives are polyalkylene oxide block copolymers which may be prepared in a particularly simple manner.

At the same time, the increase in efficiency is associated with an expansion of the temperature interval within which the microemulsion is thermodynamically stable. This is particularly advantageous for commercial applications, where stability must be ensured over large temperature ranges.

TABLE 1
Characterization of polymers

| | Mₙ | | M_{w}/Mₙ | Vol-% PEO in |
|---|---|---|---|---|
| | (hydrophobic | Mₙ | (Block | block |
| | block) | (PEO) | copolymer) | copolymer |
| PEB5-PEO5 | 3910 | 4280 | 1.04 | 47 |
| PBO5-PE05 | 6000 | 7000 | 1.07 | 50 |

TABLE 2
Polymer viscosities

| | Viscosity in Pascal-seconds | | | |
|---|---|---|---|---|
| Temperature | PB05-PEO5 | | PEB5-PEO5 | |
| in ° C. | ω = 1/sec | ω = 10/sec | ω = 1/sec | ω = 10/sec |
| 70 | 150 | 35 | 450 | 90 |
| 90 | 100 | 25 | 340 | 65 |
| 110 | 75 | 18 | 280 | 47 |
| 130 | 65 | 15 | 230 | 40 |
| 150S | 65 | 13 | 200 | 30 |

TABLE 3

| Surfactant/emulsifier | Appearance (room temperature) |
|---|---|
| Tetraoxyethlyene decyl ether | Clear liquid |
| (commercial) | |
| Mixture with average ethoxylation rate | |
| of 4) | |
| Tergitol ® 15-S-5 (Sigma) | Clear liquid |
| Tergitol ® 15-S-12 (Sigma) | Cloudy liquid |
| Tween ® 80 (Sigma) | Clear liquid |
| Tween ® 81 (Sigma) | Clear liquid |
| Span ® 20 (Sigma) | Clear liquid, highly viscous |

TABLE 4

| | Appearance of surfactant- | | Appearance of surfactant- | |
|---|---|---|---|---|
| | polymer mixtures at | | polymer-water mixtures at | |
| Surfactant/ | room temperature | | room temperature | |
| emulsifier | PBO5-PE05 | PEB5-PE05 | PB05-PEO5 | PEB5-PEO5 |
| Tetraoxy- | Liquid | Solid | Liquid | Liquid, |
| ethlyene | Cloudy | Cloudy | Clear | polymer |
| decyl ether | | | | precipitated |
| Tergitol ® | Liquid | Solid | Liquid | Liquid, |
| 15-S-5 | Cloudy | Cloudy | Clear | polymer |
| | | | | precipitated |
| Tergitol ® | Solid | Solid | Liquid | Liquid, |
| 15-S-12 | Cloudy | Cloudy | Cloudy¹⁾ | polymer |
| | | | | precipitated |
| Tween ® 80 | Solid | Solid | Liquid | Liquid, |
| | Cloudy | Cloudy | Cloudy¹⁾ | polymer |
| | | | | precipitated |
| Tween ® 81 | Solid | Solid | Liquid | Liquid, |
| | Cloudy | Cloudy | Clear | polymer |
| | | | | precipitated |
| Span ® 20 | Liquid | Liquid | Liquid | Liquid, |
| | Cloudy | Cloudy | Clear | polymer |
| | | | | precipitated |

¹⁾The mixtures were cloudy, but were still homogeneous after 5 days' storage at room temperature.

TABLE 5

| | Mₙ | M_{w}/Mₙ |
|---|---|---|
| PBO-Block | 4870 | 1.10 |
| PBO-PEO | 10,200 | 1.06 |

TABLE 6

| | Mₙ | M_{w}/Mₙ | Wt-% PEO | M_{w}/Mₙ |
|---|---|---|---|---|
| | PBO | | PBO-PEO | |
| PBO50PEO5 | 6000 | 1.11 | 54 | 1.07 |
| PEO2-PBO4-PEO2 | 4700¹ | 1.03 | 51 | 1.04 |
| | PHO | | PHO-PEO | |
| PHO10-PEO13 | 8500 | 1.08 | 59 | 1.10 |

TABLE 7
Determined interfacial tension σ between water and
oil in the H₂O - n-decane - C₈E₃ - PBO5-PEO5 system

| δ | σ/mNm⁻¹*10⁻² | T/° C. |
|---|---|---|
| 0.000 | 5.93 | 22.4 |
| 0.050 | 2.71 | 22.4 |
| 0.100 | 1.55 | 22.4 |

TABLE 8

| | Aqueous | | | Tergitol ® | |
|---|---|---|---|---|---|
| | NaCl | Decane | AOT | 15-S-12 | PBO5-PEO5 |
| Emulsion 1 | 20.0 g | 14.6 g | 0.72 g | | |
| Emulsion 2 | 20.0 g | 14.6 g | 0.36 g | 0.070 g | |
| Emulsion 3 | 20.0 g | 14.6 g | 0.18 g | 0.040 g | |
| Emulsion 4 | 20.0 g | 14.6 g | 0.36 g | | 0.071 g |
| Emulsion 5 | 20.0 g | 14.6 g | 0.18 g | | 0.041 g |

TABLE 9

Volume proportion of precipitated oil

| | 1 day | 7 days | 30 days | 120 days |
|---|---|---|---|---|
| Emulsion 1 | No oil | 4% | 45% | 46% |
| Emulstion 2 | 1% | 1% | 1% | 44% |
| Emulsion 3 | 2% | 2% | 2% | 28% |
| Emulsion 4 | No oil | No oil | No oil | No oil |
| Emulsion 5 | 2% | 2% | 2% | 1% |

1. A method for increasing the efficiency of surfactants and emulsifiers in emulsions and microemulsions by addition of additives wherein a polyalkylene oxide block copolymer comprising a water-soluble-block A and an oil-soluble block B is added to the surfactant or emulsion as an additive.

2. A method for preventing lamellar phases in water, oil, surfactant mixtures wherein a polyalkylene oxide block copolymer comprising a water-soluble block A and an oil-soluble block B is added to the surfactant or emulsion as an additive.

3. A method for stabilizing the temperature level of the single-phase mixture for oil, water, surfactant mixtures wherein a polyalkylene oxide block copolymer comprising a water-soluble block A and an oil-soluble block B is added to the oil, water, surfactant mixture as an additive.

4. A method for reducing the interfacial tension of oil and water mixtures containing surfactants and/or emulsifiers wherein a polyalkylene oxide block copolymer comprising a water-soluble block A and an oil-soluble block B is added as an additive.

5. The method according to one of claims 1 through 4 wherein block A is insoluble in oil.

6. The method according to one of claims 1 through 4 wherein block A is composed of at least one component from the monomer group comprising ethylene oxide, propylene oxide, butylene oxide, and higher alkylene oxides.

7. The method according to one of claims 1 through 4 wherein a polyethylene oxide (PEO) is used as block A.

8. The method according to claim 7 wherein a block A is used in which the monomer units occur in any given sequence.

9. The method according to claim 7 wherein blocks A are used in which the monomer units have a stochastic sequence.

10. The method according to one of claims 1 through 4 wherein block B is insoluble in water.

11. The method according to one of claims 1 through 4 wherein the monomer units of block B contain at least four carbon atoms.

12. The method according to claim 11 wherein the monomer units of block B contain at least one component from the group comprising butylene oxide, pentylene oxide, and hexylene oxide, in addition to higher alkylene oxides.

13. The method according to claim 10 wherein a block B is used which contains ethylene oxide as the monomer unit, whereby solubility in oil must still be provided.

14. The method according to one of claims 1 through 4 wherein at least one component from the group of compounds having the structure according to the pattern AB, ABA, BAB, (AB)ₙ star, or (BA)ₙ star is added as block copolymer.

15. The method according to one of claims 1 through 4 wherein a block B is used which is soluble in aliphatic hydrocarbons and/or ester oils.

16. The method according to one of claims 1 through 4 wherein block A has a molecular weight between 1000 g/mol and 50,000 g/mol.

17. The method according to one of claims 1 through 4 wherein block B has a molecular weight between 1000 g/mol and 50,000 g/mol.

18. An oil-water mixture containing at least one surfactant and/or at least one emulsifier, as well as an additive composed of a polyalkylene oxide block copolymer comprising a block A and a block B wherein block A is water-soluble and block B is oil-soluble and the mixture is a microemulsion.

19. The mixture according to claim 18 wherein at least one component from the group of AB block copolymers having the structure according to the pattern AB, ABA, or BAB, or (AB)ₙ star or (BA)ₙ star is contained as additive.

20. The mixture according to claim 18 wherein block A has a molecular weight between 1000 g/mol and 50,000 g/mol.

21. The method according to claim 18 wherein block B has a molecular weight between 1000 g/mol and 50,000 g/mol.

22. The mixture according to claim 18 wherein block A is a polyethylene oxide.

23. The mixture according to claim 22 wherein a block A is used in which the monomer units occur in any given sequence.

24. The mixture according to claim 18 wherein block B is insoluble in water.

25. The mixture according to claim 18 wherein the monomer units of block B contain least four carbon atoms.

26. The mixture according to claim 18 wherein the monomer units of block B are composed of at least one component from the group comprising butylene oxide, pentylene oxide, hexylene oxide, and higher units.

27. The mixture according to claim 18 wherein a block B contains ethylene oxide as the monomer unit, whereby solubility in oil must still be provided.

28. A surfactant or emulsifier, or mixture of surfactant and emulsifier, containing an AB polyalkylene oxide block copolymer as additive wherein the AB polyalkylene oxide block copolymer comprises a water-soluble block A and an oil-soluble block B, and contains at least five carbon atoms per monomer unit.

29. The surfactant or emulsifier, or mixture of surfactant and emulsifier, containing an AB polyalkylene oxide block copolymer according to claim 28 as additive wherein at least one component from the group of AB block copolymers having the structure according to the pattern AB, ABA, or BAB, or (AB)ₙ star or (BA)ₙ star is contained as additive.

30. The surfactant or emulsifier, or mixture of surfactant and emulsifier, containing an AB polyalkylene oxide block copolymer according to claim 28 as additive wherein block A has a molecular weight between 1000 g/mol and 50,000 g/mol.

31. The surfactant or emulsifier, or mixture of surfactant and emulsifier, containing an AB polyalkylene oxide block copolymer according to claim 28 as additive wherein block B has a molecular weight between 1000 g/mol and 50,000 g/mol.

32. The surfactant or emulsifier, or mixture of surfactant and emulsifier, containing an AB polyalkylene oxide block copolymer according to claim 28 as additive wherein block A is a polyethylene oxide.

33. The surfactant or emulsifier, or mixture of surfactant and emulsifier, containing an AB polyalkylene oxide block copolymer according to claim 28 as additive wherein a block A is used in which the monomer units occur in any given sequence.

34. The surfactant or emulsifier, or mixture of surfactant and emulsifier, containing an AB polyalkylene oxide block copolymer according to claim 28 as additive wherein block B is insoluble in water.

35. The surfactant or emulsifier, or mixture of surfactant and emulsifier, containing an AB polyalkylene oxide block copolymer according to claim 28 as additive wherein the monomer units of block B are composed of at least one component from the group comprising butylene oxide, pentylene oxide, hexylene oxide, and higher units.

36. The surfactant or emulsifier, or mixture of surfactant and emulsifier, containing an AB polyalkylene oxide block copolymer according to claim 28 as additive wherein a block B contains ethylene oxide as the monomer unit, whereby solubility in oil must still be provided.
